(19) United States
(12) Patent Application Publication
(10) Pub. No.: US 2024/0034427 A1
(43) Pub. Date: Feb. 1, 2024

(54) AUTOMATIC CONTROL SYSTEM FOR BICYCLE

(71) Applicant: TIEN HSIN INDUSTRIES CO., LTD., Taichung City (TW)

(72) Inventor: Meng-Hua Chiang, Taichung City (TW)

(73) Assignee: TIEN HSIN INDUSTRIES CO., LTD., Taichung City (TW)

(21) Appl. No.: 17/877,429

(22) Filed: Jul. 29, 2022

(51) Int. Cl. B62J 45/20; B62M 9/123; B62M 9/133; B62J 45/414; B62K 25/04; B62K 23/00; B62L 3/00

(52) U.S. Cl. CPC B62J 45/20; B62M 9/123; B62M 9/133; B62J 45/414; B62K 25/04; B62K 23/00; B62L 3/00; B62K 2025/044

(57) ABSTRACT

An automatic control system includes a host connected to the actuator and the inputting device of a bicycle. The actuator controls the motor to drive the mechanical structure to generate a displacement. The inputting device receives the external information by manually entering or automatically sensing via the inputting device to obtain an inputting parameter. In each riding journey of the predetermined path, the host records the inputting parameter that the controller of the actuator drives the motor based on and the time spent for the riding journey to form a riding information. When the rider rides the bicycle on the predetermined path again, the host selects one of the riding information, which has the shortest time spent for the riding journey, as an operating parameter for controlling the actuator, so that the host automatically controls the actuator based on the operating parameter to prevent the cyclist from distracting.

### BACKGROUND OF THE INVENTION

### Technical Field

The present disclosure relates generally to a control system for a bicycle, and more particularly to an automatic control system for a bicycle.

### Description of Related Art

When the rider rides the bicycle, the rider usually adjusts a front derailleur, a rear derailleur, an adjustable front fork, an adjustable suspension apparatus, or an adjustable seatpost during a riding journey to make the ride easier on different terrains or make the seat comfortable.

Although there are electronic derailleurs, electronic seatposts, and electronic suspension apparatuses for bicycles on the market so far, the rider has to determine when and how to adjust the derailleur, the height of the seatpost, and the resistance of the shock absorber based on the feeling of the body and the terrain of the road, which will distract the attention of the rider. Therefore, the rider can not fully concentrate during the bicycle competition, even on the route that is ridden by the rider several times.

### BRIEF SUMMARY OF THE INVENTION

In view of the above, the primary objective of the present disclosure is to provide an automatic control system, which allows a cyclist to focus on riding or the riding competition without distracting any attention to control or adjust the bicycle.

The present disclosure provides an automatic control system including a host, wherein the host is connected to an actuator and an inputting device of a bicycle. The actuator includes a controller and a mechanical device. The mechanical device includes a motor and a mechanical structure. The motor is in communication with the controller. The mechanical structure is driven by the motor to generate a displacement. The inputting device is in communication with the controller and obtains an inputting parameter by manually entering or automatically sensing an external information. The host records riding journeys on a predetermined path several times. In each of the riding journeys of the predetermined path, the inputting parameter that is used by the controller of the actuator to drive the motor and a time spent for the riding journey of the predetermined path are recorded by the host to form a riding information. One of the plurality of the riding information, which has the shortest time spent for the riding journey of the predetermined path, is selected by the host to use as an operating parameter to automatically control the actuator on the predetermined path, thereby allowing the host to automatically control the actuator based on the operating parameter when the bicycle is ridden on the predetermined path again.

With such design, when the rider rides on the predetermined path again, the actuator of the bicycle could be automatically controlled based on the operating parameters. The actuator could be controlled automatically during the riding journey of the predetermined path, thereby repeating the operation of the actuator, namely the displacement of the mechanical structure driven by the motor, of the best riding journey of the predetermined path (i.e. the fastest riding journey of the predetermined path). Thus, the rider or the cyclist will not be distracted from the competition to think about when and how to control or adjust the bicycle.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a block diagram of the automatic control system for the bicycle of an embodiment according to the present disclosure;

FIG. 2 is a block diagram of the actuator and the inputting device of the embodiment according to the present disclosure; and

FIG. 3 is a block diagram of the actuator and the inputting devices of another embodiment according to the present disclosure.

### DETAILED DESCRIPTION OF THE INVENTION

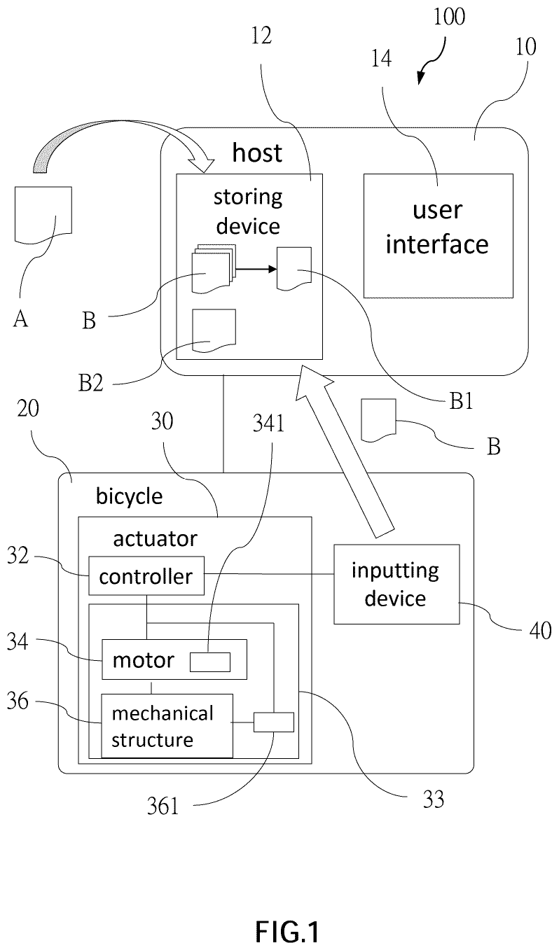

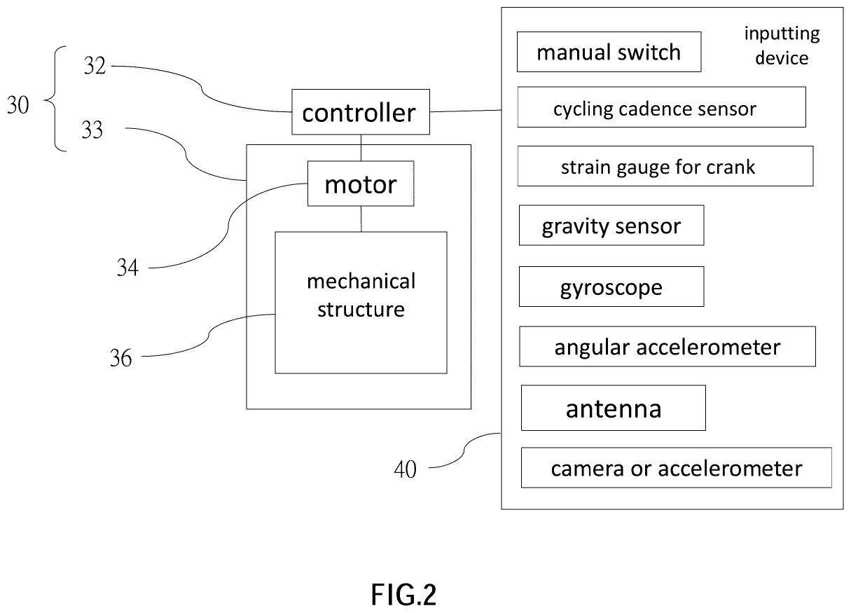

As illustrated in FIG. 1 to FIG. 2, an automatic control system 100 for a bicycle 20 of an embodiment according to the present disclosure includes a host 10, the bicycle 20, at least one actuator 30, and an inputting device 40, wherein the actuator 30 and the inputting device 40 are mounted on the bicycle 20 and are connected to the host 10.

The host 10 is a terminal or a computer and has a storing device 12 and a user interface 14. The bicycle 20 is provided for a rider or a cyclist to repeatedly ride on a path. When the bicycle 20 is ridden by the rider on the path, the host 10 is connected to a satellite positioning system to constantly receive a path positioning information via a GPS module to form a predetermined path A. The predetermined path A could be a path positioning information that is transmitted via a wire or without a wire to the host 10. The predetermined path A is stored in the storing device 12 and could be set or selected through the user interface 14 of the host 10. The user interface 14 is a touchscreen or a screen with buttons.

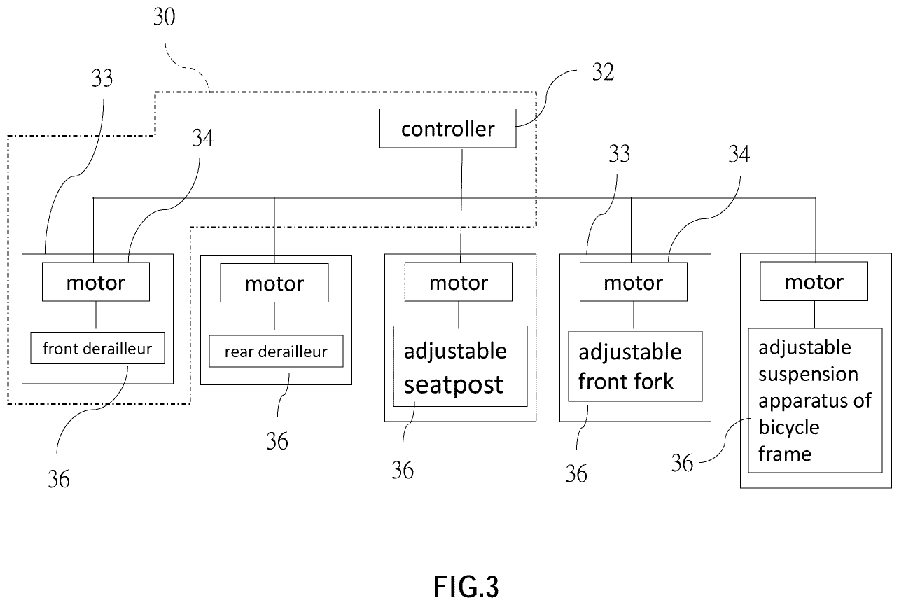

The at least one actuator 30 could be an electronic front derailleur, an electronic rear derailleur, an electronic seatpost, an electronic front fork, or an electronic suspension apparatus. The actuator 30 includes a controller 32 and a mechanical device 33, wherein the mechanical device 33 includes a motor 34 and a mechanical structure 36. As illustrated in FIG. 3, the mechanical structure 36 could be a front derailleur, a rear derailleur, an adjustable seatpost, an adjustable front fork, or an adjustable suspension apparatus. The motor 34 is in communication with the controller 32, and the mechanical structure 36 is driven by the motor 34 to operate, i.e. the electronic front derailleur and the electronic rear derailleur are driven to shift the chain, the electronic seatpost is driven to adjust the height of the paddle, the electronic adjustable front fork is driven to adjust the height of the front fork, the electronic suspension apparatus is driven to adjust the shock absorber to provide proper viscous friction. As illustrated in FIG. 1 to FIG. 2, when the bicycle 20 includes two or more actuators 30, each of the motors 34 of the mechanical devices 33 could be connected to one of the controllers 32. In other embodiments, the motors 34 of the mechanical devices 33 could be connected to the same controller 32, as shown in FIG. 3.

The inputting device 40 is in communication with the controller 32 and could be a manual switch of the actuator 30, which is mounted on the bicycle 20. In other embodiments, the inputting device 40 includes a strain gauge for a crank, a tachometer for a crank, a gravity sensor, a gyroscope, an angular accelerometer, an antenna, a camera, an accelerometer, or a combination thereof. The inputting device 40 is manually operated by the rider of the bicycle 20 to enter an inputting parameter B. In other embodiments, the inputting parameter B could be obtained by measuring or capturing the information of the environment or the bicycle 20 via the sensor or capturing device of the inputting device 40. The inputting parameter B which is inputted through the inputting device 40 could be a position that the mechanical structure 36, which is driven by the motor 34 of the actuator is about to move to, a status of the actuator 30, a strain applied to the crank, a cycling cadence, a positioning information, a terrain, an image information of the predetermined path A, or a combination thereof.

Every time the rider rides the bicycle 20 on the predetermined path A, the actuator 30 is operated to control the motor 34 to drive the mechanical structure 36 via the controller 32 according to the inputting parameters B during the riding journey. The host records the riding journey when the rider rides the bicycle 20 on the predetermined path A several times in the storing device 12. In other words, the host 10 records the displacement of the mechanical structure 36 driven by the motor 34 of the actuator 30 during the riding journey of the predetermined path A. The inputting parameter B that is recorded could further include the parameters measured and captured through the aforementioned sensors. The host 10 records the time spent for the riding journey of the predetermined path A via the storing device 12. The time spent for the riding journey of the predetermined path A and the inputting parameter B during the riding journey of the predetermined path A are combined to form a riding information C.

One of the riding information C recorded in the storing device 12, which has the shortest time, is selected by the host 10, and the inputting parameter B in the selected one of the riding information C is used as an operating parameter B1 for automatically controlling the actuator 30 during riding on the predetermined path A. Thus, when the rider rides the bicycle 20 on the predetermined path A again, the host 10 could compare the parameter obtained via the inputting device 40 at real-time with the inputting parameter B of the selected one of the riding information C to determine whether the real-time parameter is conformed to the inputting parameter B or not. More specifically, determine whether a positioning information, a terrain, or an image information captured by the inputting device 40 at real-time during a riding journey of the predetermined path A is conformed to the positioning information, the terrain, or the image information in the inputting parameter B or not. When the real-time parameter is conformed to the inputting parameter B that is recorded, the motor 34 controllably drives the mechanical structure 36 to move a predetermined displacement at the same location on the predetermined path A based on the inputting parameter B of the selected one of the riding information C, thereby repeating the displacement of the mechanical structure 36 during the riding journey of the predetermined path A, which has the best performance. Thus, the rider or the cyclist could focus on riding or the competition without considering when and how to control the bicycle 20.

Furthermore, the host 10 of the automatic control system 100 of the present disclosure could conduct a calculation to obtain an optimized inputting parameter B2 based on the inputting parameter B, wherein the optimized inputting parameter B2 is used as the operating parameter B1 for automatically controlling the actuator 30 when riding on the predetermined path A. When the rider rides the bicycle 20 on the predetermined path A again, the rider could control the host 10 to load the optimized inputting parameter B2 or not via the user interface 14. When the optimized inputting parameter B2 is loaded to the host 10, the host 10 will automatically control the actuator 30 based on the optimized inputting parameter B2 on the predetermined path A.

The mechanical device 33 further includes an electric control switch 361 for controlling an operation status of the mechanical structure 36. The electric control switch 361 is electronically connected to the controller 32 and is adapted to control a using status of the mechanical structure 36 based on the operating parameter B1 on the predetermined path A. The mechanical structure 36 could be a decelerating device, and the motor 34 is disposed with an outputting shaft 341. The mechanical structure 36 is disposed on the outputting shaft 341 and is driven by the motor 34, thereby changing a transmission of the motor 34 to generate a rotating displacement.

It must be pointed out that the embodiment described above is only a preferred embodiment of the present disclosure. All equivalent structures and methods which employ the concepts disclosed in this specification and the appended claims should fall within the scope of the present disclosure.

What is claimed is:

1. An automatic control system for a bicycle, comprising:
a host connected to an actuator and an inputting device of the bicycle, wherein the actuator comprises a controller and a mechanical device; the mechanical device comprises a motor and a mechanical structure; the motor is in communication with the controller; the mechanical structure is driven by the motor to operate; the inputting device is in communication with the controller and obtains an inputting parameter by manually entering or automatically sensing an external information;
wherein the host records riding journeys of a predetermined path several times; in each of the riding journeys of the predetermined path, the inputting parameter that is used by the controller of the actuator to drive the motor and a time spent for the riding journey of the predetermined path are recorded by the host to form a riding information;
wherein one of the plurality of the riding information, which has the shortest time spent for the riding journey of the predetermined path, is selected by the host to use as an operating parameter for automatically controlling the actuator on the predetermined path, thereby allowing the host to control the actuator based on the operating parameter when the bicycle is ridden on the predetermined path again.

2. The automatic control system as claimed in claim 1, wherein the inputting device comprises a strain gauge, a cycling cadence sensor, a gravity sensor, a gyroscope, an angular accelerometer, an antenna, a camera, an accelerometer, or a combination thereof.

3. The automatic control system as claimed in claim 2, wherein the inputting parameter comprises an image information, a positioning information, a terrain of the predetermined path, a status of the actuator, a cycling cadence, a strain applied to the crank, or a combination thereof; the host conducts a calculation to obtain an optimized inputting parameter based on the inputting parameter, wherein the optimized inputting parameter is used as the operating parameter for automatically control the actuator on the predetermined path.

4. The automatic control system as claimed in claim 3, wherein when the bicycle is ridden on the predetermined path, the host is controllably operated to load the optimized inputting parameter to automatically control the actuator.

5. The automatic control system as claimed in claim 1, wherein the predetermined path is a path positioning information that is obtained through a satellite positioning system.

6. The automatic control system as claimed in claim 4, wherein the predetermined path could be set through a user interface of the host; the user interface is used for operating the host to load the optimized inputting parameter or not.

7. The automatic control system as claimed in claim 1, wherein the mechanical structure is a front derailleur, a rear derailleur, an adjustable seatpost, an adjustable front fork, or an adjustable suspension apparatus.

8. The automatic control system as claimed in claim 7, wherein the mechanical device further comprises an electric control switch; the electric control switch is adapted to control an operation status of the mechanical device based on the operating parameter for automatically controlling the mechanical device when the bicycle is ridden on the predetermined path.

9. The automatic control system as claimed in claim 8, wherein the electric control switch is disposed in the mechanical device to control an operation of the mechanical device, and the electric control switch controls the mechanical device based on the operating parameter.

10. The automatic control system as claimed in claim 1, wherein the mechanical structure is a decelerating device, and the motor is disposed with an outputting shaft; the decelerating device is disposed on the outputting shaft to change a transmission ratio of the motor.
